(19) United States
(12) Patent Application Publication
(10) Pub. No.: US 2020/0250443 A1
(43) Pub. Date: Aug. 6, 2020

(54) INFORMATION PROCESSING DEVICE, SERVER, AND TRAFFIC MANAGEMENT SYSTEM

(71) Applicant: TOYOTA JIDOSHA KABUSHIKI KAISHA, Toyota-shi (JP)

(72) Inventors: Yuhei SUZUKI, Kariya-shi (JP); Yoshihiro Ohe, Kawasaki-shi (JP); Ayana Takeshita, Kasugai-shi (JP); Shunsuke Tanimori, Susono-shi (JP); Ryosuke Tanimura, Nisshin-shi (JP); Hiromitsu Fujii, Kariya-shi (JP)

(73) Assignee: TOYOTA JIDOSHA KABUSHIKI KAISHA, Toyota-shi (JP)

(21) Appl. No.: 16/745,578

(22) Filed: Jan. 17, 2020

(30) Foreign Application Priority Data
Feb. 1, 2019 (JP) 2019-017383

(51) Int. Cl. G06K 9/00; G06T 7/00; H04N 7/18

(52) U.S. Cl. CPC G06K 9/00818; G06T 7/0002; G06T 2207/30252; H04N 7/181; H04N 7/188

(57) ABSTRACT

In a traffic management system including a plurality of vehicles and a server, each vehicle is configured to generate an image including a traffic sign during traveling, and transmit, to the server, the image including the traffic sign, and the server is configured to compare the image of the traffic sign transmitted from each vehicle with reference traffic sign images, accumulate a plurality of evaluation results of evaluating visibility of the traffic sign, and based on the accumulated plurality of evaluation results, determine a state of the traffic sign.

### INCORPORATION BY REFERENCE

The disclosure of Japanese Patent Application No. 2019-017383 filed on Feb. 1, 2019 including the specification, drawings and abstract is incorporated herein by reference in its entirety.

### BACKGROUND

### 1. Technical Field

The disclosure relates to an information processing device, a server, and a traffic management system, and more particularly, to an information processing device, a server, and a traffic management system that detect deterioration over time, or the like, of a road sign.

### 2. Description of Related Art

In general, a road sign installed outdoors has extremely high visibility when installed, but deterioration of paint, adherence, or the like, of dirt due to changes over time results in deterioration in visibility. In recent years, a technology of automatically recognizing road signs based on a moving image acquired by an image capturing unit of a vehicle has been studied, and a sign identification device that reliably recognizes the kind and content of a road sign that has deteriorated over time has been proposed.

For example. Japanese Unexamined Patent Application Publication No. 2016-196233 discloses a road sign visibility device for a vehicle having an image capturing unit that captures an image in front of the proceeding direction of the vehicle with sensitivity in the visible light region and the near-infrared region, and a near-infrared light irradiation unit. The technology determines whether an image of a road sign can be captured by using a near-infrared moving image, and in a case where the image of the road sign can be captured, the technology recognizes the kind and content of the road sign by an image obtained by combining a near-infrared image and a color image.

### SUMMARY

The causes for the difficulty in recognizing a road sign are not only deterioration over time, but also a case where branches and leaves of trees, or the like, adjacent to the road sign obstruct visibility, or a case where the direction of the road sign is changed due to damage to the road sign, or the like. Among the cases, in the case where an object that obstructs the visibility occurs or in the case where the traffic sign is damaged, or the like, it is necessary to immediately remove the obstruction or repair the damage. Moreover, even when the cause is deterioration over time, the signs must be replaced depending on the degree of deterioration. However, it has been difficult to identify a road sign that requires a certain treatment because there has been no method.

Accordingly, in consideration of the above issues, a purpose of the present disclosure is to provide an information processing device, a server, and a traffic management system capable of identifying a traffic sign (a road sign, a road marking, a traffic light, or the like) the visibility of which has deteriorated.

A traffic management system according to an embodiment of the present disclosure includes a plurality of vehicles and a server. Each of the vehicles is configured to generate an image including a traffic sign during traveling, and transmit, to the server, the image including the traffic sign, and the server is configured to compare an image of the traffic sign transmitted from each of the vehicles with reference images of the traffic sign, accumulate a plurality of evaluation results of evaluating visibility of the traffic sign, and based on the accumulated plurality of evaluation results, determine a state of the traffic sign.

An information processing device according to an embodiment of the present disclosure is an information processing device of a vehicle having an image capturing unit, and includes a storage unit configured to store map information including at least an installation position of a traffic sign, a control unit configured to compare the installation position of the traffic sign in the map information with position information of the vehicle, and when the vehicle reaches a position where the traffic sign is visible, control the image capturing unit, such that the image capturing unit captures an image including the traffic sign, and a communication unit configured to transmit, to a server, the image including the traffic sign and the position information of the vehicle when the image is captured.

The information processing device according to an embodiment of the present disclosure is an information processing device of the vehicle having the image capturing unit. The information processing device includes a control unit configured to analyze the image captured by the image capturing unit during traveling, and determine whether the image includes the traffic sign, and a communication unit configured to, in a case where the image includes the traffic sign, transmit, to the server, the image including the traffic sign and the position information of the vehicle when the image is captured.

In addition, a server according to an embodiment of the present disclosure includes a storage unit and a control unit. The storage unit is configured to accumulate the image including the traffic sign transmitted from each of a plurality of vehicles, read reference images of the traffic sign, and accumulate a plurality of evaluation results of evaluating visibility of the traffic sign, and the control unit is configured to compare the transmitted image of the traffic sign with the reference images of the traffic sign, evaluate the visibility of the traffic sign, and, based on the accumulated plurality of evaluation results of the visibility of the traffic sign, determine a state of the traffic sign.

With an information processing device, a server, and a traffic management system of the present disclosure, it is possible to identify a traffic sign visibility of which has deteriorated.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram describing an embodiment that determines a state of a traffic sign;

FIG. 2 is a block diagram describing an example of a traffic management system according to the embodiment;

FIG. 3A is an example of a traffic sign that has just been installed;

FIG. 3B is an example of a traffic sign that has deteriorated over time:

FIG. 3C is an example of a traffic sign in a state where displayed content is difficult to be visible;

FIG. 4 is a flowchart illustrating an operation of the information processing device according to the embodiment:

FIG. 5 is a flowchart illustrating another operation of the information processing device according to the embodiment; and

FIG. 6 is a flowchart illustrating an operation of a server of the traffic management system according to the embodiment.

### DETAILED DESCRIPTION OF EMBODIMENTS

Hereinafter, an embodiment of the present disclosure will be described.

### EMBODIMENT

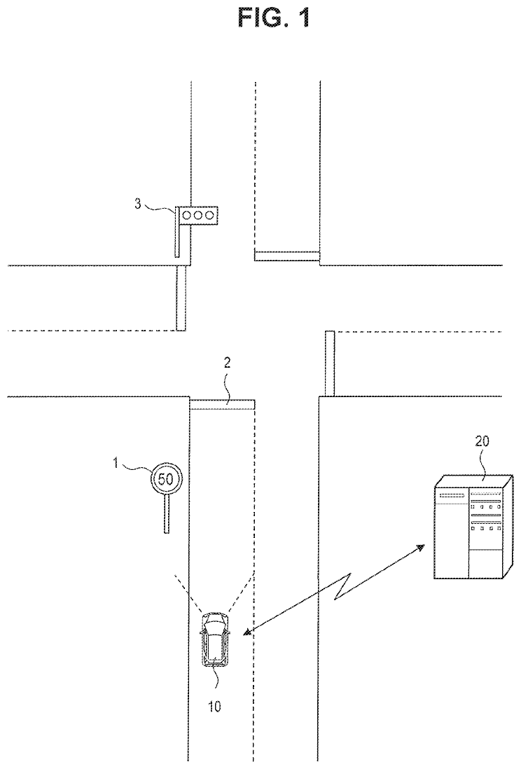

FIG. 1 is a diagram describing an embodiment that determines a state of a traffic sign.

FIG. 1 illustrates a vehicle 10 and a center (a server) 20 approaching an intersection. Targets managed by a traffic management system of the present disclosure are various signs and markings that display information related to traffic, for example, a road sign 1 installed using a pole along a road, a road marking 2, such as a stop line, directly drawn on the road, a traffic light 3, and the like. In the present specification, various signs, markings, and the like, which display information related to traffic are collectively referred to as “traffic signs”. In addition, a place where a traffic sign is visible is not limited to an intersection, and may be any place where a traffic sign installed on any road is visible as a target.

Moreover, in FIG. 1, a sign that displays the maximum speed limit is exemplified as the road sign 1, but the content displayed on the traffic sign is not limited thereto. Moreover, any shape may be used for the traffic sign, for example, not only a round sign as above, but also a square sign that divides traffic according to the traveling direction, and a triangular sign that indicates temporary stop.

During traveling, the vehicle 10 acquires an image of the traffic sign (the road sign 1, the road marking 2, the traffic light 3, and the like) by an image capturing unit (an in-vehicle camera), and transmits image data to the server 20 together with position information of the vehicle 10. In addition, although only one vehicle 10 is illustrated in FIG. 1, there may be a plurality of vehicles 10. Each vehicle 10 transmits the acquired traffic sign image data to the server 20. Moreover, the vehicle is not limited to a gasoline vehicle, and may be an electric vehicle, a hybrid vehicle (HV), a fuel cell vehicle (FCV), or the like.

The server 20 receives the image data from the vehicle 10. The server 20 collects images including the traffic sign from a plurality of vehicles 10, and accumulates the images in a database (a storage unit). Further, the server 20 compares the image of the traffic sign with images of the same traffic sign accumulated in past image data, evaluates visibility of the traffic sign (degree of deterioration in the visibility), and determines a state of the traffic sign from a plurality of evaluation results. The determination result is also recorded in the database. Determination results of states of the traffic signs accumulated in the database may be transmitted to the outside as traffic sign management data, or in response to access to the database by a traffic sign management department, the data (the determination results) may be provided.

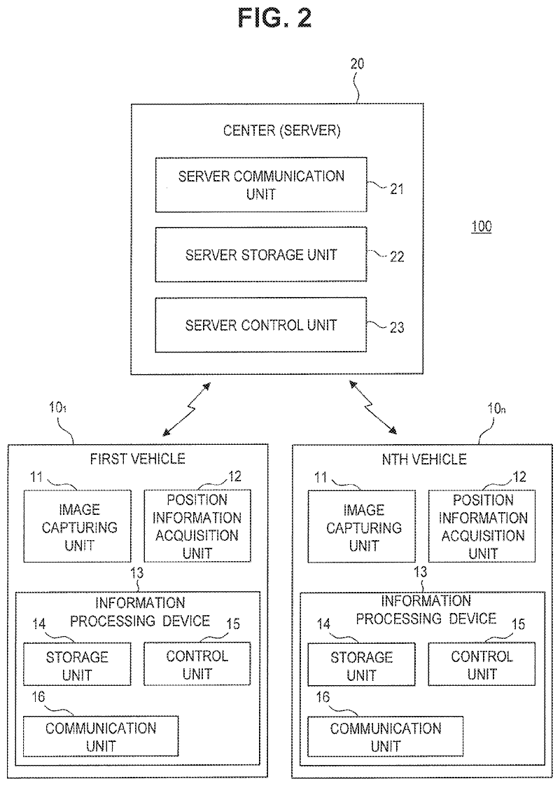

Next, a traffic management system that determines the state of the traffic sign will be described. FIG. 2 is an overall view of an example of the traffic management system 100 according to one embodiment of the present disclosure. The traffic management system 100 includes the center (the server) 20, and the server 20 receives information from the plurality of vehicles 10 (first vehicle 10₁, . . . , nth vehicle 10ₙ).

The vehicle 10 (10₁, . . . , 10ₙ) includes an image capturing unit 11, a position information acquisition unit 12, and an information processing device 13. The information processing device 13 includes a storage unit 14, a control unit 15, and a communication unit 16. Since each vehicle 10 has the same configuration, only the first vehicle 10₁ is described.

The image capturing unit 11 is a so-called in-vehicle camera, and includes a camera that captures an image in front (outside) of the vehicle. The image capturing unit 11 may be a drive recorder that generates continuous moving images in front of the vehicle while the vehicle is traveling or is stopped, and records the generated moving image in the storage unit 14. In the present embodiment, the image capturing unit 11 generates (films) a moving image including a traffic sign when approaching the traffic sign (the road sign 1, the road marking 2, the traffic light 3, and the like).

The position information acquisition unit 12 includes one or more receivers corresponding to any satellite positioning system. For example, the position information acquisition unit 12 may include a global positioning system (GPS) receiver. The position information acquisition unit 12 detects information of the position (particularly, an image acquisition position where the image including the traffic sign is acquired) of a subject vehicle 10.

The information processing device 13 is mounted on the vehicle 10 and performs processing, such as control of the vehicle 10 and acquisition and transmission of a moving image of the traffic sign. The information processing device 13 includes a storage unit 14, a control unit 15, and a communication unit 16.

The storage unit 14 records and stores various kinds of information, and includes one or more memories. The “memory” is, for example, a semiconductor memory, a magnetic memory, or an optic memory, but is not limited thereto. Each memory included in the storage unit 14 may function as, for example, a primary storage device, a secondary storage device, or a cache memory. The storage unit 14 stores any information related to an operation of the vehicle 10. For example, the storage unit 14 stores the moving image generated by the image capturing unit 11 and the position information acquired by the position information acquisition unit 12 in association with time information at the time when the moving image is generated. In the present embodiment, it is also useful for the storage unit 14 to store map information indicating the installation position and the content of the traffic sign. In addition, the storage unit 14 may store information on a result of analysis and processing, by the control unit 15, of the generated moving image. Further, the storage unit 14 accumulates various kinds of information on an operation or control of the vehicle, such as storage of a program that controls the subject vehicle 10.

The control unit 15 includes one or more processors. The “processor” may be a general-purpose processor, or a processor dedicated to a specific process. For example, an electronic control unit (ECU) mounted on the vehicle 10 may function as the control unit 15. The control unit 15 controls overall operation of the first vehicle. For example, the control unit 15 performs control of the image capturing unit 11, the position information acquisition unit 12, the storage unit 14, and the communication unit 16, and overall control of traveling and operation of the subject vehicle. The control unit 15 may analyze an image. In the present embodiment, for example, the control unit 15 may analyze the moving image generated by the image capturing unit 11 and detect the traffic sign.

The communication unit 16 includes a communication module that performs communication between the subject vehicle 10 and the server 20. The communication unit 16 may include a communication module connected to a network or a communication module corresponding to a mobile communication standard, such as Fourth Generation (4G) or Fifth Generation (5G) mobile communication. For example, an in-vehicle communication device, such as a data communication module (DCM), mounted on the vehicle 10, may function as the communication unit 16. In the present embodiment, the communication unit 16 may transmit, to the server 20, the generated moving image of the traffic sign in addition to the position information of the vehicle.

The center (the server) 20 includes a server communication unit 21, a server storage unit 22, and a server control unit 23.

The server communication unit 21 includes a communication module that performs communication between the server 20 and the vehicle 10. The server communication unit 21 may include a communication module connected to the network. The server communication unit 21 may receive information (detection position information of the traffic sign, moving image data of the traffic sign, and the like) transmitted from the vehicle 10 (first vehicle 10₁, . . . . nth vehicle 10ₙ). Further, information on the determination results of the state of the traffic sign may be transmitted (provided) to the outside.

The server storage unit 22 records and stores various kinds of information, and includes one or more memories. The “memory” is, for example, a semiconductor memory, a magnetic memory, or an optic memory, but is not limited thereto. Each memory included in the server storage unit 22 may function as, for example, a primary storage device, a secondary storage device, or a cache memory. The server storage unit 22, for example, accumulates information (the detection position information of the traffic sign, the moving image data of the traffic sign, and the like) transmitted from each vehicle 10 (first vehicle 10₁, . . . , nth vehicle 10ₙ). In addition, the server storage unit 22 may store information on a result of analysis and processing, by the server control unit 23, of the received information. Further, the server storage unit 22 accumulates various kinds of information on an operation or control of the entire server and the system.

The server control unit 23 includes one or more processors. The “processor” may be a general-purpose processor, or a processor dedicated to a specific process. The server control unit 23 performs control of the server communication unit 21 and the server storage unit 22, and performs overall control of an operation of the entire server and the information system. Moreover, in the present embodiment, the server control unit 23 functions as a determination unit that analyzes the information (the detection position information of the traffic sign, the moving image data of the traffic sign, and the like) transmitted from each vehicle 10 (first vehicle 10₁, . . . , nth vehicle 10ₙ), evaluates the visibility of the traffic sign, determines the state of the traffic sign, and the like.

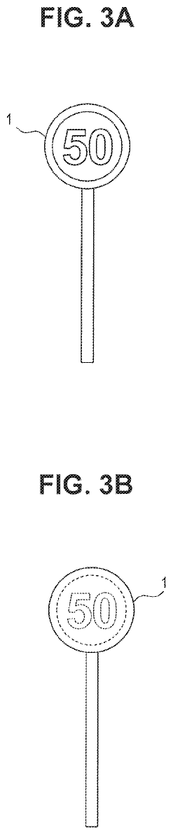

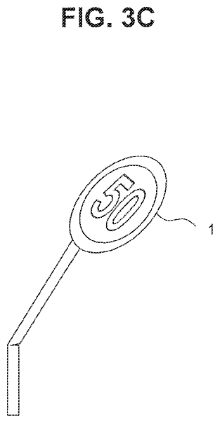

FIGS. 3A, 3B, and 3C describe changes in the visibility of the traffic sign.

FIG. 3A is an example of a traffic sign, which has just been installed and the visibility of which is in a good state. FIG. 3B is an example of a traffic sign which has deteriorated over time, and the visibility of which has reduced due to deterioration or peeling of paint caused by wind and rain. In addition. FIG. 3C an example of a state in which the direction of the traffic sign is changed due to damage of a traffic sign pole, and the like, and it is difficult for a vehicle passing on the road to visually recognize the content displayed on the traffic sign.

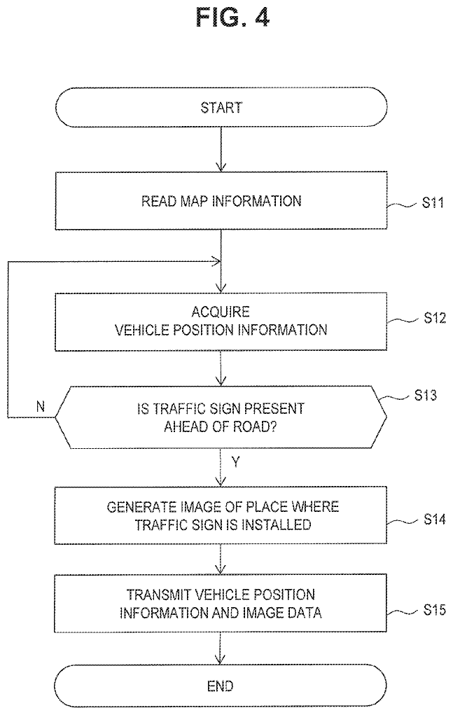

FIG. 4 is a flowchart illustrating an operation of the information processing device 13 of the vehicle 10. FIG. 4 illustrates processing of a case where the information processing device 13 of the vehicle 10 includes map information indicating the installation position of the traffic sign. The processing of the information processing device 13 of the vehicle 10 will be described in detail with reference to the flowchart in FIG. 4.

Step S11: First, the information processing device 13 reads, from the storage unit 14, the map information indicating the installation position of the traffic sign and the content of the traffic sign. In addition, the map information may be downloaded from the server 20 via the communication unit 16 at any time.

Step S12: The information processing device 13 acquires, from the position information acquisition unit 12, the position information of the subject vehicle 10 during traveling.

Step S13: The information processing device 13 associates the acquired position information with the map information, and the control unit 15 determines whether a traffic sign is installed ahead of the road on which the vehicle is traveling, that is, whether the vehicle is at a position where the traffic sign can be visible. When the traffic sign is installed (when the vehicle reaches the position where the traffic sign can be visible), the process proceeds to step S14, and when the traffic sign is not installed, the process returns to step S12.

Step S14: The information processing device 13 controls the image capturing unit 11, and, based on the map information, generates an image of a place where the traffic sign is installed. In this case, it is not necessary for the control unit 15 of the information processing device 13 to visually recognize the traffic sign from the image, such that the processing of the control unit 15 is reduced. Moreover, when it is difficult for the traffic sign to be visible, the image including the traffic sign can be reliably acquired based on the map information. In addition, when the moving image is always generated by the image capturing unit 11 and accumulated in the storage unit 14, the image of the place where the traffic sign is installed may be extracted from the accumulated moving image.

Step S15: Using the communication unit 16, the information processing device 13 transmits, to the server 20, the vehicle position information acquired in step S12 and the image data including the traffic sign generated in step S14. Thereafter, the processing of the information processing device 13 is ended.

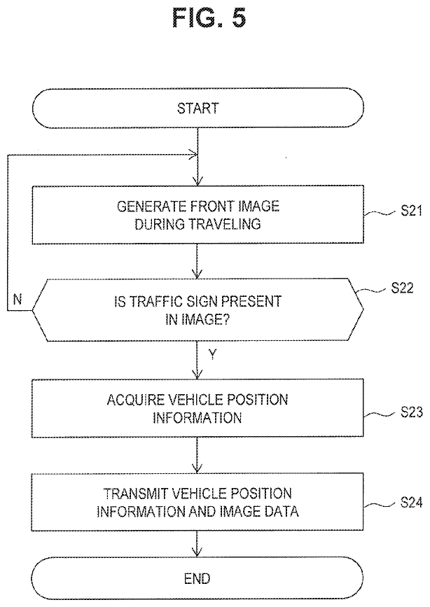

FIG. 5 is a flowchart illustrating another operation of the information processing device 13 of the vehicle 10. FIG. 5 illustrates processing of a case where the information processing device 13 of the vehicle 10 includes the map information indicating the installation position of the traffic sign. In addition, for the traffic management system 100, any of the processing of FIGS. 4 and 5 can be employed. The processing of the information processing device 13 of the vehicle 10 will be described in detail with reference to the flowchart in FIG. 5.

Step S21: First, the information processing device 13 controls the image capturing unit 11 during traveling, and the image capturing unit 11 generates the moving image (the image) in front of the vehicle 10.

Step S22: Next, the information processing device 13 analyzes the moving image (image) generated by the image capturing unit 11, and determines whether the traffic sign is present in the moving image. The determination can be made by performing, by the control unit 15, predetermined image processing on the generated moving image. For example, whether the road sign 1 is present in the image can be determined by searching for a closed area surrounded by edges in the captured image and obtaining the size, position, color gradation, average pixel value, and the like, of the found closed area. Further, whether the road marking 2 is present in the image can be determined by obtaining the size, shape, color gradation, luminance, and the like, of a mark drawn on the road. Whether the traffic light 3 is present can also be determined from an image. When it is determined that the traffic sign is present, the process proceeds to step S23, and when it is determined that the traffic sign is not present, the process returns to step S22.

Step S23: The information processing device 13 acquires, from the position information acquisition unit 12, the position information (the position information of the vehicle when the image is captured) of the subject vehicle during traveling.

Step S24: Using the communication unit 16, the information processing device 13 transmits, to the server 20, the vehicle position information acquired in step S23 and the image data in which it is determined that the traffic sign is present in step S22. Thereafter, the processing of the information processing device 13 is ended.

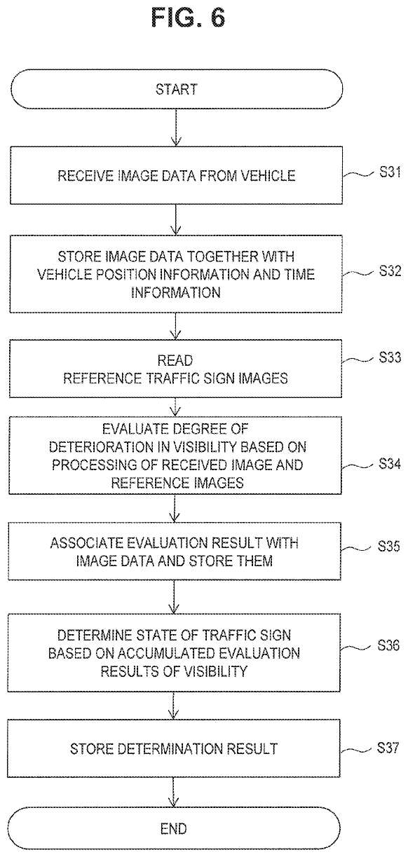

FIG. 6 is a flowchart describing an operation of a server 20 of the traffic management system 100. Processing of the server 20 will be described in detail with reference to the flowchart in FIG. 6.

Step S31: First, the server communication unit 21 of the server 20 receives the image data transmitted from the vehicle 10 (the information processing device 13). In addition, the server communication unit 21 also receives the vehicle position information at the time when the image data is acquired.

Step S32: The server 20 stores, in the server storage unit (database) 22, the received image data together with the vehicle position information and the time information. Further, the time information can be added based on the reception time on the server 20 side, but the time when the image data is acquired on the vehicle 10 side can be added to the image data and transmitted, such that a more accurate time information can be obtained.

Step S33: The server 20 reads, from the server storage unit 22, reference sign images (reference images of the traffic sign) corresponding to the traffic sign included in the received image data. The reference sign images serve as reference images used for evaluating the degree of deterioration of the traffic sign in the image data. The reference sign images may be image data indicating an ideal traffic sign, or images of an actual traffic sign captured at the same place at the same time range in the past (before deterioration progresses). When a target to be compared is a fixed reference sign image, stable evaluation can be performed.

Step S34: The server 20 compares the image data received from the vehicle 10 with the reference sign images read in step S33, and evaluates the visibility of the traffic sign (the degree of deterioration in the visibility). For example, the server 20 compares the traffic sign image in the image data received from the vehicle 10 with the reference sign images in terms of a level of a pixel value, and obtains differences between the shape, color gradation, brightness, and the like. The server 20 can analyze and evaluate the differences as the degree of deterioration in the visibility from the reference sign images (for example, by obtaining a multi-dimensional distance from the reference sign images).

In addition, in evaluating the deterioration in the visibility, the deterioration in the visibility due to surrounding conditions (an external factor) may be also evaluated in addition to the deterioration of the traffic sign itself (an internal factor). For example, trees around the traffic sign may grow and obstruct the sign. Moreover, when a structure having a similar color to that of the sign may be installed in the background of the traffic sign or in a nearby place, it may be difficult for the traffic sign to be recognized.

Among the above situations, when an object that obstructs the sign (an obstruction of the visibility) occurs, the presence of the object is perceived by a change in the shape of the image of the traffic sign, or changes in color gradation and luminance. Thus, the changes can serve as evaluating factors of the degree of deterioration. However, the deterioration in the visibility due to changes in the background or surroundings cannot be evaluated only by comparing traffic sign images. Therefore, in the received image data, the degree of similarity of the traffic sign to the surroundings is examined in terms of color gradation, brightness, and the like, and when the traffic sign is similar to the surroundings in terms of color gradation, brightness, and the like, an evaluation that the visibility is poor may be added. This is an effective method of making a more accurate evaluation.

Step S35: The server 20 associates the evaluation result of the visibility, obtained in step S34 with the image data, and stores them in the server storage unit 22.

Step S36: For one traffic sign, the server 20 accumulates, in the server storage unit 22, a plurality of evaluation results of the visibility based on the image data transmitted from many vehicles 10. There, the server control unit 23 of the server 20 comprehensively evaluates the visibility of the traffic sign based on the plurality of accumulated evaluation results of the visibility, and determines the state of the traffic sign. For example, even when there is one piece of data having a poor evaluation result of the visibility, it is difficult to determine only with one piece of data whether the traffic sign has deteriorated or the image capturing unit 11 of the vehicle 10, which has acquired the image, has deteriorated. For example, when the fact that the visibility gradually deteriorates over time is supported by a large number of data pieces, it can be determined that the traffic sign has deteriorated over time. Further, when there is a sign having good visibility and the visibility has suddenly deteriorated from a certain time and the state continues, it can be determined that the traffic sign has been damaged for some reason. In this manner, the state of the traffic sign is determined based on the evaluation results of the plurality of traffic signs.

Step S37: The server 20 accumulates, in the server storage unit 22, the determination result of the state of the traffic sign, obtained in step S36. Thereafter, the process is ended.

Then, the determination result of the state of the traffic sign, accumulated in the server storage unit (database) 22, is provided to the outside (for example, the department that maintains and manages the traffic sign), and repairs are performed in order from the traffic sign in a poor state, and the like. As such, it will be helpful to perform efficient repair work.

As described above, according to the present disclosure, it is possible to identify a traffic sign the visibility of which has deteriorated and which is in a poor state, and to efficiently repair the traffic sign.

In the above embodiment, an example of the image processing method is shown in which whether a traffic sign is present in an image is determined in the information processing device of the vehicle, or the visibility of the traffic sign is evaluated in the server. However, the image processing method is not limited to the example. For example, any image recognition algorithm, such as pattern matching, feature extraction, and machine learning, may be employed.

In the above embodiment, the configuration and the operation of the traffic management system 100 have been described, but the present disclosure is not limited thereto. The above embodiment may be configured as a traffic management method that accumulates images including a traffic sign transmitted from a plurality of vehicles, reads reference images of the traffic sign, compares the images including the transmitted traffic sign with the reference traffic sign images, accumulates results of evaluation of the visibility, and determines the state of the traffic sign based on a plurality of accumulated evaluation results.

In addition, a computer can be used suitably in order to function as the information processing device 13 or the server 20 of the vehicle 10. The computer stores, in a storage unit of the computer, a program describing the processing details that implement each function of the information processing device 13 or the server 20, reads the program on a CPU of the computer, and performs the program such that the function of the information processing device 13 or the server 20 can be implemented. In addition, the program can be recorded on a computer-readable recording medium.

Although the above embodiment has been described as a representative example, it will be apparent to those skilled in the art that variations and substitutions can be made within the scope of the present disclosure. Therefore, the present disclosure should not be construed as being limited to the above embodiment, and variations and modifications can be made without departing from the scope of the claims. For example, a plurality of configuration blocks described in the embodiment can be combined into one, or one configuration block can be divided.

What is claimed is:

1. A traffic management system comprising:
a plurality of vehicles, each of which is configured to generate an image including a traffic sign during traveling; and
a server, wherein:
each of the vehicles is configured to transmit to the server, the image including the traffic sign;
the server is configured to compare an image of the traffic sign transmitted from each of the vehicles with reference images of the traffic sign, accumulate a plurality of evaluation results of evaluating visibility of the traffic sign, and based on the accumulated plurality of evaluation results, determine a state of the traffic sign.

2. The traffic management system according to claim 1, wherein the server is configured to further accumulate the plurality of evaluation results of evaluating the state of the traffic sign, and provide the evaluation results to the outside as information.

3. The traffic management system according to claim 1, wherein the server is configured to accumulate the image of the traffic sign transmitted from each of the vehicles, and the reference images of the traffic sign are the images of the traffic sign accumulated in the past.

4. An information processing device of a vehicle having an image capturing unit, the information processing device comprising:
a storage unit configured to store map information including at least an installation position of a traffic sign;
a control unit configured to compare the installation position of the traffic sign in the map information with position information of the vehicle, and when the vehicle reaches a position where the traffic sign is visible, control the image capturing unit such that the image capturing unit captures an image including the traffic sign; and
a communication unit configured to transmit, to a server, the image including the traffic sign and the position information of the vehicle when the image is captured.

5. An information processing device of a vehicle having an image capturing unit, the information processing device comprising:
a control unit configured to analyze an image captured by the image capturing unit during traveling, and determine whether the image includes a traffic sign, and
a communication unit configured to transmit, when the image includes the traffic sign, to a server, the image including the traffic sign and position information of the vehicle when the image is captured.

6. A server comprising:
a storage unit configured to accumulate an image including a traffic sign transmitted from each of a plurality of vehicles, read reference images of the traffic sign, and accumulate a plurality of evaluation results of evaluating visibility of the traffic sign; and
a control unit configured to compare the transmitted image of the traffic sign with the reference images of the traffic sign, evaluate the visibility of the traffic sign, and, based on the accumulated plurality of evaluation results of the visibility of the traffic sign, determine a state of the traffic sign.
